(19) United States
(12) Patent Application Publication
(10) Pub. No.: US 2026/0195182 A1
(43) Pub. Date: Jul. 9, 2026

(54) METHOD AND VEHICLE FOR MANAGING RESOURCE OF CONTROLLER

(71) Applicants: Hyundai Motor Company, Seoul (KR); Kia Corporation, Seoul (KR)

(72) Inventors: Wang Seok LEE, Hwaseong-Si (KR); Soo Myung JUNG, Hwaseong-Si (KR)

(21) Appl. No.: 19/419,675

(22) Filed: Dec. 15, 2025

(30) Foreign Application Priority Data
Jan. 6, 2025 (KR) 10-2025-0001385

(51) Int. Cl. G06F 9/50

(52) U.S. Cl. CPC G06F 9/5027

(57) ABSTRACT

Disclosed herein a method and vehicle for managing resource of controller. The method includes: monitoring a component data amount used by a plurality of components having dependencies in a controller and a bus data amount transmitted on bus paths used by the components; determining whether one or more of the component data amount or the bus data amount is greater than or equal to respective maximum usage amount; and reducing a resource of the component to reduce a component data amount of a reduction component determined based on reduction information, in response to the data amount being greater than or equal to the maximum usage amount.

### CROSS-REFERENCE TO RELATED APPLICATION

This application claims the benefit of priority to Korean Patent Application No. 10-2025-0001385, filed in the Korean Intellectual Property Office on Jan. 6, 2025, the disclosure of which is incorporated herein by reference in its entirety.

### FIELD OF TECHNOLOGY

The present disclosure relates to a method and vehicle for managing resource of a controller, and more particularly, to a method and vehicle for managing resource of a controller that stably distribute resources of the controller in high-speed communication.

### BACKGROUND

A vehicle has been commercialized with various functions for driving convenience. For this purpose, an autonomous driving function or a manual driving support function is supported by the vehicle. In order to perform such a function, a software defined vehicle (SDV) may be used.

The software architecture of a vehicle according to SDV switching is directed toward simplification and high performance as the required functions may increase. To this end, a controller of the vehicle involves communication via high-speed input/output devices, and the amount of data used in each device and communication may also continuously increase.

When performing software logic, in addition to resources of a processor core such as a CPU and a GPU, resource management in the high-speed input/output device may also be required.

### SUMMARY

The present disclosure is to provide a method and vehicle for managing resource of a controller that stably distribute resources of the controller in high-speed communication.

The various examples of the present disclosure are not limited to the above-mentioned technical problems, and other technical problems that are not mentioned will be clearly understood by those skilled in the art to which the present disclosure belongs from the description below.

According to the present disclosure, a method performed by a vehicle may comprise monitoring an amount of data used by a plurality of circuits having dependencies in a processor of the vehicle and an amount of bus data transmitted on bus paths used by the plurality of circuits. The method may further comprise determining whether at least one of the amount of data or the amount of bus data is greater than or equal to a respective threshold usage amount. Based on reduction information of the vehicle and a determination that at least one of the amount of data or the amount of bus data is greater than or equal to the respective threshold usage amount, the method may include determining a reduction target circuit among the plurality of circuits, outputting a signal instructing to reduce an amount of data used by the reduction target circuit, and controlling, based on the signal, operations of the vehicle.

According to the present disclosure, a vehicle may comprise a plurality of circuits configured to control operations of the vehicle, a plurality of bus paths configured to exchange data between the plurality of circuits, a memory configured to store at least one reduction parameter associated with the vehicle, wherein the at least one reduction parameter may comprise at least one reduction limit amount and at least one reduction priority for at least one of the plurality of circuits, and a processor circuit configured to determine an amount of data used by the plurality of circuits and an amount of bus data transmitted on the plurality of bus paths, determine whether at least one of the amount of data or the amount of the bus data exceeds a respective threshold usage amount, and based on the respective threshold usage amount being exceeded and the at least one reduction parameter, select the at least one of the plurality of circuits as a reduction target.

The processor circuit may further be configured to, based on the at least one reduction limit amount and the at least one reduction priority, output a signal indicating to adjust a data usage of the reduction target, and control, via the plurality of circuits and based on the signal, operations of the vehicle. The processor circuit may be configured to classify the plurality of circuits into high-priority circuits and low-priority circuits based on the at least one reduction parameter, and based on the respective threshold usage amount being exceeded, use the at least one reduction parameter to select at least one of the low-priority circuits as the reduction target and reduce the data usage of the reduction target.

The processor circuit may be configured to adjust the at least one reduction limit amount based on a change in processing executed in the plurality of circuits, wherein the adjustment of the at least one reduction limit amount may comprise increasing the at least one reduction limit amount for processing using a neural processing unit, and decreasing the at least one reduction limit amount for processing not using the neural processing unit. The processor circuit may be configured to set a reduction priority of each of the plurality of circuits based on an operation of the vehicle, by assigning a lower reduction priority to circuits that perform a priority function in the operation, and assigning a higher reduction priority to circuits that perform a non-priority function in the operation.

The processor circuit may be configured to output, via a user interface of the vehicle, a message requesting resource distribution, based on the data usage of the reduction target having been reduced to at or below the at least one reduction limit amount, and wherein the at least one reduction limit amount may correspond to a minimum amount of data that must be allowed for the reduction target to use.

According to the present disclosure, a vehicle may comprise a processor and a memory storing at least one instruction that, when executed by the processor, may cause the vehicle to monitor an amount of data used by a plurality of circuits having dependencies in control circuitry and an amount of bus data transmitted on bus paths used by the plurality of circuits. The vehicle may further be configured to determine whether at least one of the amount of data or the amount of bus data is greater than or equal to a respective threshold usage amount, determine, based on reduction information of the vehicle and a determination that at least one of the amount of data or the amount of bus data is greater than or equal to the respective threshold usage amount, a reduction target circuit among the plurality of circuits, output a signal indicating to reduce an amount of data used by the reduction target circuit, and control, based on the signal, operations of the vehicle.

The bus paths may comprise a plurality of bus paths generated based on routing of a Network on Chip (NOC). The plurality of circuits may comprise a reference circuit for which management of resource is required and an association circuit that depends on the reference circuit, and the bus paths may comprise a bus path that depends on the reference circuit and is used by the association circuit.

The threshold usage amount for the amount of data and the threshold usage amount for the amount of bus data may be set respectively for the association circuit and the reference circuit. The plurality of circuits may comprise a reference circuit for which management of resource is required and an association circuit that depends on the reference circuit, wherein the reduction information may be configured to reduce the amount of data, and wherein the amount of data may be used by the association circuit.

The reduction information may comprise a reduction limit amount, wherein the reduction limit amount may correspond to a minimum amount of data that must be allowed for the association circuit to use, and the at least one instruction, when executed by the processor, may cause the vehicle to determine whether the association circuit is using an amount of data less than or equal to the reduction limit amount, and reduce the amount of data used by the association circuit based on a determination that the amount of data exceeds the reduction limit amount. The reduction limit amount may be adjusted based on a change in processing executed in the plurality of circuits.

The at least one instruction, when executed by the processor, may cause the vehicle to transmit a message requesting resource distribution of the reference circuit, based on the reduction target circuit being operated with an amount of data less than or equal to the reduction limit amount. The reduction information may comprise a reduction priority assigned to each of the plurality of circuits, and the at least one instruction, when executed by the processor, may cause the vehicle to reduce an amount of data of the reduction target circuit, wherein the reduction target circuit may be selected based on a corresponding reduction priority. The at least one instruction, when executed by the processor, may cause the vehicle to adjust the reduction priority based on a change in processing executed in the plurality of circuits.

The features briefly summarized above for this disclosure are only exemplary examples of the detailed description of the disclosure which follow, and are not intended to limit the scope of the disclosure.

### BRIEF DESCRIPTION OF THE DRAWINGS

The above and other objects, features and advantages of the present disclosure will become more apparent to those of ordinary skill in the art by describing one or more example implementations thereof in detail with reference to the accompanying drawings, in which:

FIG. 1 shows an example of a vehicle communicating with another device to transmit and receive data.

FIG. 2 shows exemplary modules that constitutes the vehicle.

FIG. 3 shows an example of modules of a controller implemented in a processor.

FIG. 4 shows an example of modules that constitutes a server.

FIG. 5 shows an example of a resource management method of a controller.

FIG. 6 shows an example of reduction information including the maximum usage amount and reduction data.

FIG. 7 shows another example of the reduction information including maximum usage amount and reduction data.

FIG. 8 shows an example computing system (e.g., a computing device of a vehicle or any other apparatus).

### DETAILED DESCRIPTION

Hereinafter, exemplary implementations of the present disclosure will be described in detail with reference to the accompanying drawings so that those skilled in the art may easily implement the present disclosure. However, the present disclosure may be implemented in various different ways, and is not limited to the implementations described therein.

In describing exemplary implementations of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an implementation could be termed a second element in another implementation, and, similarly, a second element in an implementation could be termed a first element in another implementation, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed implementations are included in the scope of the present disclosure.

In the present disclosure, elements described in various implementations do not necessarily mean essential elements, and some of them may be optional elements. Therefore, an implementation composed of a subset of elements described in an implementation is also included in the scope of the present disclosure. In addition, implementations including other elements in addition to the elements described in the various implementations are also included in the scope of the present disclosure.

The advantages and features of the present disclosure and the way of attaining them will become apparent with reference to implementations described below in detail in conjunction with the accompanying drawings. Implementations, however, may be varied in many different forms and should not be constructed as being limited to example implementations set forth herein. Rather, these implementations are provided so that this disclosure will be complete and will fully convey the scope of the disclosure to those skilled in the art.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of reducing data usage of circuitry based on threshold usage amount and reduction parameters) described herein, an operation of the vehicle may be controlled.

For example, during high-level autonomous driving (e.g., Level 3 or higher), the vehicle controller may monitor the total data usage of circuits involved in autonomous driving control, such as perception processors (e.g., LiDAR and camera circuits), sensor fusion circuits, and vehicle control buses. When the monitored data usage or bus traffic exceeds a respective threshold usage amount, the controller may apply reduction parameters to lower the data rate or processing frequency of non-critical subsystems (e.g., infotainment display updates, cabin environment monitoring, or redundant sensor fusion channels). This ensures that critical real-time control tasks such as lane detection, obstacle avoidance, and trajectory planning maintain sufficient computational and communication resources.

In another example, when the vehicle transitions from a fully autonomous mode (e.g., highway pilot mode) to a semi-autonomous mode (e.g., urban assist mode), the processor may dynamically adjust reduction parameters to increase data priority for circuits related to pedestrian detection and traffic signal recognition, while reducing resource allocation for circuits associated with high-resolution mapping or remote monitoring. Conversely, when overall data usage drops below the threshold usage amount, normal operation of all circuits may be restored.

Accordingly, by controlling features associated with autonomous driving based on the feature of reducing data usage of circuitry according to threshold usage amount and reduction parameters, the vehicle may ensure stable operation of critical autonomous control loops, maintain safe driving performance, and prevent overload of computational or communication resources during complex driving scenarios.

One or more auxiliary devices (e.g., engine brake, exhaust brake, hydraulic retarder, electric retarder, regenerative brake, etc.) may also be controlled, for example, based on one or more features (e.g., feature of reducing data usage of circuitry based on threshold usage amount and reduction parameters) described herein.

For example, during downhill driving or high-load braking conditions, the controller may monitor data usage among multiple circuits associated with auxiliary braking control—such as electric retarder control circuits, regenerative brake controllers, and inverter communication buses. When the total data or bus traffic amount exceeds a threshold usage amount due to simultaneous processing of braking torque commands and battery recovery data, the processor may apply reduction parameters to selectively reduce data usage of lower-priority circuits. For instance, the controller may temporarily decrease the sampling rate of auxiliary brake temperature sensors or delay non-critical logging processes, thereby ensuring sufficient processing bandwidth for regenerative braking torque computation and coordination with the main brake ECU.

In another example, when regenerative braking operates concurrently with an electric retarder during an emergency deceleration event, the data usage of both torque feedback circuits and power distribution buses may surge. Upon detecting this condition, the processor may reduce data transmission associated with auxiliary monitoring units (e.g., driver-assistance torque analysis or maintenance monitoring circuits) according to a predefined reduction priority. Once the braking load is reduced and the total data usage falls below the threshold usage amount, normal data rates of the auxiliary devices may be restored.

Accordingly, by controlling auxiliary devices based on the feature of reducing data usage of circuitry according to threshold usage amount and reduction parameters, the vehicle may prevent control delays, maintain stable braking response, and ensure reliable operation of the braking control network even under high-load or regenerative braking conditions.

One or more communication devices (e.g., a modem, a network adapter, a radio transceiver, an antenna, etc.) that are capable of communicating via one or more wired or wireless communication protocols, such as Ethernet, Wi-Fi, near-field communication (NFC), Bluetooth, Long-Term Evolution (LTE), 5G New Radio (NR), or vehicle-to-everything (V2X), may also be controlled, for example, based on one or more features (e.g., feature of reducing data usage of circuitry based on threshold usage amount and reduction parameters) described herein.

For example, during high-bandwidth communication over a 5G or V2X network, the controller may monitor the total data usage of communication circuits and buses, such as those associated with the modem, antenna array, and Ethernet interface. When the amount of transmitted or received data exceeds a predefined threshold usage amount, the processor may apply reduction parameters to temporarily lower the transmission rate or data packet size for non-critical communication channels (e.g., infotainment streaming, remote diagnostics, or over-the-air update tasks). This allows the system to allocate communication bandwidth and processing resources preferentially to safety-critical functions, such as real-time exchange of vehicle-to-vehicle (V2V) hazard alerts or cooperative perception data.

In another example, when the vehicle enters an autonomous driving mode requiring continuous cloud-based navigation updates, the controller may prioritize LTE or 5G uplink communication for sensor data upload while reducing Wi-Fi-based cabin device communication or Bluetooth audio data throughput according to the reduction parameters. Conversely, when the overall network load decreases below the threshold usage amount, the controller may release the reduction state and restore normal communication throughput.

Accordingly, by controlling the data usage of communication circuitry based on threshold usage amount and reduction parameters, the vehicle may prevent bus congestion, maintain low-latency connectivity for critical communication links, and ensure stable network performance even under heavy data-exchange conditions.

Minimum risk maneuver (MRM) operation(s) may also be controlled, for example, based on one or more features (e.g., feature of reducing data usage of circuitry based on threshold usage amount and reduction parameters) described herein. A minimal risk maneuvering operation (e.g., a minimal risk maneuver, a minimum risk maneuver) may be a maneuvering operation of a vehicle to minimize (e.g., reduce) a risk of collision with surrounding vehicles or obstacles to reach a lowered (e.g., minimum) risk state.

During execution of such an MRM, the vehicle controller may monitor the total data usage of circuits and bus paths associated with driving assistance systems (e.g., perception, decision, and actuation circuits) and determine whether the usage exceeds a threshold usage amount. When the vehicle transitions into an MRM mode (e.g., decelerating safely to the road shoulder after driver unresponsiveness), the processor may apply reduction parameters to selectively reduce data usage of non-critical subsystems (e.g., infotainment, telematics upload, or cabin monitoring circuits), thereby reserving computational and bus resources for essential safety-related operations such as LiDAR-based obstacle detection, RADAR-based distance tracking, and braking control.

For example, when the MRM operation is initiated due to a driver not responding to a takeover request, and LiDAR and RADAR circuits produce high-frequency perception data exceeding a threshold usage amount, the processor may temporarily reduce or suspend data transmission of secondary circuits (e.g., rear seat occupant monitoring or V2X communication update channels). Conversely, after the vehicle reaches a minimal risk state and stabilizes at a stop, the controller may restore normal data usage for previously reduced components according to the reduction parameters.

Accordingly, by dynamically controlling data usage of circuitry based on threshold usage amount and reduction parameters during minimum risk maneuver operations, the vehicle may maintain stable communication bandwidth, prevent overload of critical safety circuits, and ensure timely control execution for risk-minimizing maneuvers.

Biased driving operation(s) may also be controlled, for example, based on one or more features (e.g., feature of reducing data usage of circuitry based on threshold usage amount and reduction parameters) described herein. A driving control apparatus may perform a biased driving control while managing the controller's internal resources to maintain communication stability among multiple sensor and processor circuits during dynamic maneuvers.

To perform biased driving, the driving control apparatus may control the vehicle to drive in a lane by maintaining a lateral distance between the center of the vehicle and the center of the lane. When performing such control, the controller may monitor the data usage of multiple circuits associated with driving perception and path planning (e.g., LiDAR processing circuitry, radar front-end processors, and camera interface buses). If the total bus data amount or component data amount exceeds a threshold usage amount during frequent lane-keeping or bias adjustments, the processor may apply reduction parameters to selectively reduce the data usage of non-critical circuitry. For example, while a biased driving control keeps the vehicle slightly offset from the center of the lane to maintain a safe distance from large adjacent vehicles, the processor may temporarily lower the data frame rate of rear cameras or interior monitoring circuits, thereby ensuring sufficient bandwidth for real-time front-sensor data processing.

In another example, during a lane-change or obstacle-avoidance biasing maneuver, when the controller detects increased data flow from radar and LiDAR circuits, the processor may reduce communication throughput of peripheral circuits (e.g., infotainment Ethernet links or diagnostic bus interfaces) according to their reduction priority. Conversely, when the biased driving operation stabilizes and the total data usage falls below the threshold usage amount, the processor may gradually restore normal data usage for those circuits.

Accordingly, by dynamically adjusting data usage of circuitry based on threshold usage amount and reduction parameters during biased driving operations, the vehicle may maintain reliable perception, minimize processing delay, and ensure stable control performance even when multiple sensors and communication channels are simultaneously active.

One or more sensors (e.g., IMU sensors, camera, LiDAR, RADAR, blind-spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of reducing data usage of circuitry based on threshold usage amount and reduction parameters) described herein.

For instance, when sensor data traffic exceeds a threshold usage amount, the controller may selectively reduce data usage of one or more circuitry associated with non-critical sensing operations while maintaining full data throughput for safety-critical sensors. For example, when a LiDAR sensor and a RADAR sensor are simultaneously active during autonomous driving, and the bus data amount on a network-on-chip (NOC) path exceeds a threshold, the controller may reduce the frame rate or data packet size of a secondary sensor (e.g., a rear camera or ultrasonic sensor) according to predefined reduction parameters, thereby maintaining stable communication for the primary LiDAR and RADAR signals.

Similarly, in low-speed or parking scenarios, when the overall processing load of the controller decreases below the threshold usage amount, the processor may release previously applied reductions and restore normal data usage for auxiliary sensors (e.g., parking cameras or ultrasonic sensors). In another example, during heavy rain detected by a rain sensor or when visibility drops according to a light sensor, the controller may increase the reduction priority of image-based sensors and allocate more bus bandwidth to RADAR-based detection circuitry.

Accordingly, by dynamically adjusting the data usage of circuitry based on the threshold usage amount and reduction parameters, the vehicle may maintain stable sensor communication, prevent bus congestion, and ensure reliable perception performance under various sensing conditions and environmental states.

An autonomous driving level and/or autonomous driving activation/deactivation may also be controlled, for example, based on one or more features (e.g., feature of reducing data usage of circuitry based on threshold usage amount and reduction parameters) described herein. A driving control apparatus may perform an autonomous driving level control (e.g., a change of an autonomous driving level, a change of required user attentiveness, etc.) or cause deactivation of an autonomous driving operation based on the reduction processing of controller circuitry. For example, when the vehicle is operating in a high-level autonomous driving mode (e.g., SAE level 4 or 5), the controller may monitor the data usage of a plurality of circuits and bus paths, such as those associated with an Ethernet module, a DRAM, or a PCIe interface, and selectively reduce data usage of non-critical circuits (e.g., infotainment or diagnostic subsystems) once a threshold usage amount is exceeded. Conversely, when the vehicle transitions to a lower-level or manual driving mode, the controller may reallocate bandwidth to circuits supporting real-time driver assistance functions (e.g., camera-based lane keeping, adaptive cruise control, or steering torque sensors).

In another example, when autonomous driving is deactivated and user intervention is required, the processor may reduce communication or data traffic for components used only during fully autonomous operation (e.g., LiDAR fusion processors or cloud-based path planning circuits) according to reduction parameters, thereby conserving system bandwidth and preventing latency in circuits required for driver-controlled functions. In contrast, when autonomous driving is activated again, the controller may restore or increase the maximum usage amount of those circuits, enabling high-throughput data exchange necessary for perception and decision-making tasks.

Accordingly, by adaptively reducing or restoring data usage of circuitry based on threshold usage amount and reduction parameters, the vehicle may maintain stable controller operation across varying autonomous driving levels and driving states while improving processing efficiency and communication stability.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

According to the present disclosure, a vehicle and method are provided for managing resources of a processor circuit that executes high-speed communications and control processes within the vehicle. The vehicle may include a plurality of sensors, communication circuitry, and control circuitry exchanging large amounts of data over internal bus paths. The processor circuit of the vehicle may monitor an amount of data used by a plurality of circuits and an amount of bus data transmitted on the bus paths. When one or more of the amount of data or the amount of bus data meets or exceeds respective defined threshold usage amounts, the processor circuit may reduce a resource of an association circuit determined based on stored reduction information, including reduction limits and priorities, to suppress delays and stably distribute resources among the plurality of circuits. This arrangement enables continuous and reliable operation of vehicle functions, including autonomous or driver-assisted driving, even under heavy data loads.

Hereinafter, implementations of the present disclosure will be described with reference to the accompanying drawings.

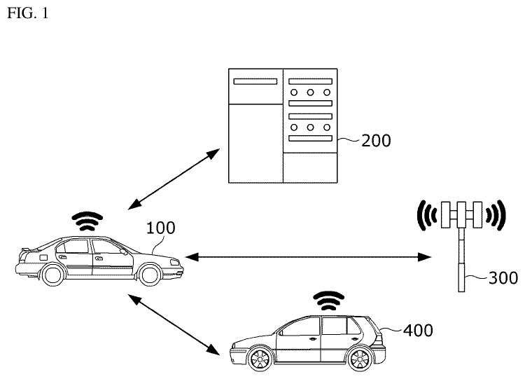

Hereinafter, a vehicle that manages resource of a controller that performs a process related to control of the vehicle will be described with reference to FIGS. 1 to 3.

FIG. 1 shows an example of a vehicle communicating with another device to transmit and receive data.

Referring to FIG. 1, a vehicle 100 may be driven based on electric energy or fossil energy. In the case of electric energy, the vehicle 100 may employ, for example, a pure battery-based vehicle driven only by a high-voltage battery or a gas-based fuel cell as an energy source (e.g., a hydrogen fuel-cell electric vehicle or a plug-in battery EV, etc.). In addition, the fuel cell may use various types of gas capable of generating electric energy, and the gas may be filled into the vehicle 100 in a liquefied state, for example. Here, the gas may be hydrogen as an example. However, the gas is not limited thereto, and various gases may be applied (e.g., methane, natural gas, or ammonia, etc.). In the case of fossil energy, the vehicle 100 is driven by fuel such as gasoline, diesel, or liquefied gas, and may be equipped with an internal combustion engine that drives an actuating unit 116 by combustion of the fuel. The engine may be included in a power source unit 114 from the viewpoint of providing a driving rotational force of a wheel to a wheel driving unit (not shown) of the actuating unit 116. As another example, the vehicle 100 may drive the actuating unit 116 by selectively utilizing the energy of the fossil energy-based internal combustion engine and the electric battery, which may be a hybrid type vehicle (e.g., HEV, PHEV, or mild-hybrid, etc.).

The vehicle 100 may refer to a moveable device. The vehicle 100 is a ground vehicle that drives on the ground and may be a conventional passenger or commercial vehicle, a Purpose Built Vehicle (PBV), or the like (e.g., a ride-hailing shuttle, last-mile delivery robot, or logistics platform, etc.). The vehicle 100 may be a four-wheeled vehicle, such as a passenger car, an SUV, a small truck, or may be a vehicle with more than four wheels, such as a bus, a large truck, a container carrying vehicle, a heavy-equipment vehicle, and the like. The vehicle 100 may be a robot in a broad sense, such as a moving means, and the robot may be moved using wheels, tracks, or other moving modules (e.g., articulated legs, crawler treads, or omni-directional rollers, etc.). The present disclosure described below may also be applied to robots and the like.

The vehicle 100 may be controlled to be driven by manual driving or autonomous driving due to the driving of a user. The autonomous driving may be implemented as semi-autonomous driving or fully autonomous driving. The fully autonomous driving may be provided as autonomous driving in which a processor 120 of the vehicle 100 completely controls without user intervention even if the driving situation is uncertain (e.g., unexpected road obstacles or traffic pattern changes, etc.). The semi-autonomy driving may be provided by autonomous driving in which driver intervention is required according to a specific driving situation (e.g., highway merging, complex intersections, or emergency response, etc.). According to the level of autonomous driving defined by the American Society of Automotive Engineers (SAE), the semi-autonomous driving may correspond to the autonomous driving levels 1 to 4, and the fully autonomous driving may correspond to level 5.

Meanwhile, the vehicle 100 may communicate with other devices 200 and 300 or another vehicle 400. The other devices may include, for example, a server 200 that supports various controls, state management, and driving of the vehicle 100, an intelligent transportation system (ITS) device 300 for receiving information from the ITS, various types of user devices, and the like (e.g., smartphones, tablets, or wearable devices, etc.). The server 200 is, for example, an external device operated by a vehicle manufacturer or provided for servicing a driving support function, and may receive connected data of the vehicle 100 or transmit data necessary for manual and autonomous driving (e.g., map updates, firmware updates, or route optimization data, etc.). The server 200 may transmit various information and software modules used for controlling the vehicle 100 to the vehicle 100 in response to requests and data transmitted from the vehicle 100 and a user device, so as to support driving and various services of the vehicle 100 (e.g., over-the-air (OTA) updates, infotainment downloads, or safety alerts, etc.).

The ITS device 300 is, for example, a Roadside Base Station (RSU), and the ITS device 300 may mutually exchange vehicle recognition data, driving control and state data, environmental data around the vehicle, map data, and the like via V2I with the vehicle 100 to assist the user in driving the own vehicle or support autonomous driving of the vehicle 100 (e.g., traffic signal information, lane closure warnings, or congestion updates, etc.). The vehicle 100 may mutually exchange the above-listed data via V2V with the other vehicle 400 to support manual driving or autonomous driving (e.g., cooperative braking, platooning, or collision avoidance, etc.).

The vehicle 100 may communicate with other vehicles or other devices based on cellular communication, Wireless Access in Vehicular Environment (WAVE) communication, Dedicated Short Range Communication (DSRC) or near field communication, or other communication schemes (e.g., Bluetooth LE or Ultra-Wideband (UWB), etc.).

For example, the vehicle 100 may use as a cellular communication network such as a communication network such as LTE or 5G, a WiFi communication network, a WAVE communication network, etc., for communication with the server 200, the ITS device 300, and the other vehicle 400 (e.g., through 5G NR-V2X, Wi-Fi 6E, or DSRC IEEE 802.11p, etc.). For another example, a DSRC or the like used in the vehicle 100 may also be used for communication between vehicles. A communication manner between the vehicle 100, the server 200, the ITS device 300 and another vehicle 400 and a user device is not limited to the foregoing implementation.

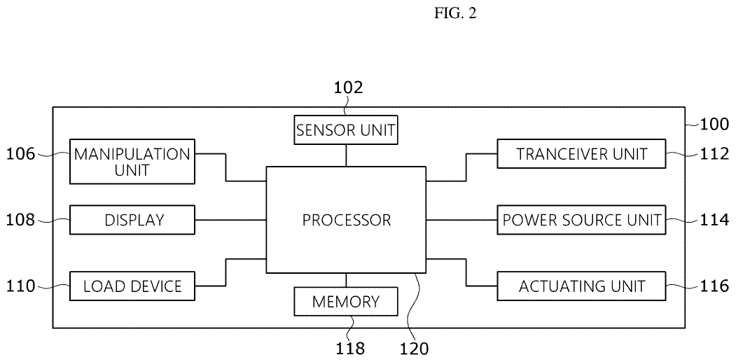

FIG. 2 shows an example of modules that constitute the vehicle according to an implementation of the present disclosure.

The vehicle 100 may include a sensor unit 102, an operation unit 106, a display 108, a load device 110, and a transmission/reception unit 112.

The sensor unit 102 may include various types of detectors for sensing various states and situations occurring in an external environment, an internal system, a user operation, and a boarding space of the vehicle 100 (e.g., temperature, occupancy, and light sensors, etc.). The sensor unit 102 may include an externally-oriented camera, a lidar sensor, a radar sensor, and the like so as to recognize dynamic and static objects existing outside the vehicle 100 (e.g., pedestrians, vehicles, or road signs, etc.). The sensor unit 102 may include a positioning sensor, a wheel sensor, a posture sensor, and the like to check its own position, speed, driving posture, and the like (e.g., GNSS receiver, IMU, or odometry sensor, etc.). A detection module that detects various situations not listed here may be further included in the sensor unit 102 (e.g., a rain sensor, cabin CO₂ sensor, or biometric sensor, etc.).

The operation unit 106 may be configured as a module for a user to control for driving. For example, the operation unit 106 may include a steering wheel for manual driving, an automatic or manual transmission actuator, an accelerator pedal, a brake pedal, a gear transmission, or the like (e.g., paddle shifters, electronic gear selectors, or haptic feedback controls, etc.). The operation unit 106 further includes an interface for use, release, and selection of detailed functions of an autonomous driving mode requested by the user, so that the user uses the autonomous driving function (e.g., engaging adaptive cruise or lane centering, etc.). The operation unit 106 may be configured as, for example, a hard-type interface provided at a predetermined position inside the vehicle 100 or a soft-type interface touchable on the display 108, so as to receive various requests related to autonomous driving (e.g., mode selection or path confirmation, etc.).

The display 108 may function as a user interface. The display 108 may display, by the processor 120, an operation state of the vehicle 100, a control state, path/traffic information, remaining energy information, content requested by a driver, and the like to be output (e.g., 3D navigation maps, ADAS visualizations, or infotainment menus, etc.). In addition, the display 108 may be configured as a touch screen capable of detecting driver input, and may receive a request of the driver instructing the processor 120.

The load device 110 is mounted on the vehicle 100, and may be a type of non-driving electric device excluding a driving power system such as a wheel driving unit 118. The load device 110 may be an auxiliary device that receives power from the power source unit 114, and may be, for example, an air conditioning system, an indicator lamp system, a lighting system, a seat system, and various devices installed in the vehicle 100 (e.g., seat heater, window defroster, or infotainment amplifier, etc.).

The transmission/reception unit 112 may support mutual communication with the server 200, the ITS device 300, the surrounding vehicle 400, and the like. For example, the transmission/reception unit 112 may include a module that processes cellular communication, WAVE, DSRC communication, and the like (e.g., a 5G modem, Wi-Fi transceiver, or DSRC module, etc.). In the present disclosure, the transmission/reception unit 112 may transmit data generated or stored during driving to the server 200, and receive data and a software module transmitted from the server 200 (e.g., OTA updates, diagnostic logs, or route data, etc.). The transmission/reception unit 112 also may support communication with an electronic device carried by a passenger inside the vehicle 100 (e.g., smartphone pairing via Bluetooth or UWB, etc.). In the present disclosure, the vehicle 100 may transmit and receive data utilized in the method according to the present disclosure to and from the outside, through the transmission/reception unit 112.

The vehicle 100 may also include the power source unit 114 and the actuating unit 116.

The power source unit 114 may generate and supply power and electric power to be used for a driving power system and a non-driving power system, such as the actuating unit 118 (e.g., DC/DC converters or inverters, etc.). The non-driving power system may be, for example, the sensor unit 102, the operation unit 106, the display 108, the load device 110, the transmission/reception unit 112, and the like, and is not limited thereto, and may include various components that implement sensing, interface, communication, and convenience functions except for components directly involved in a driving operation (e.g., cabin electronics or infotainment subsystems, etc.).

When the vehicle 100 is driven on an electric energy basis, the power source unit 114 may be composed of, for example, an electric battery that is charged from the outside, or may be composed of a combination of an electric battery and a fuel cell that charges the battery (e.g., Li-ion battery and PEM fuel cell combination, etc.). In the case of a combination of the electric battery and the fuel cell, the power source unit 114 may include a tank that stores a material used to generate electric power of the fuel cell, such as liquefied hydrogen (e.g., cryogenic hydrogen tank or high-pressure composite cylinder, etc.). When the vehicle 100 may be driven on a fossil energy basis, the power source unit 114 may include an internal combustion engine. Further, when the vehicle 100 is of a hybrid type, the power source unit 114 may be provided by a combination of the internal combustion engine and the electric battery.

The actuating unit 116 includes at least one module that implements a driving operation, and may perform at least one of a longitudinal control such as acceleration and deceleration, a transverse control such as steering, and a gear shift according to a user request from the operation unit 106 or a request of the processor 120 (e.g., executing a trajectory or controlling torque output, etc.). Here, the gear shift may be processed by a request of a manual driving user using a gear transmission or the processor 120 in autonomous driving.

The actuating unit 116 may include a wheel driving unit(not shown), a mechanical component and an electronic module for implementing a driving operation on the wheel driving unit, so as to implement a driving operation according to a command of the processor 118 by a user's manual operation or autonomous driving (e.g., an electric motor controller or steering actuator, etc.). When the vehicle 100 is operated based on electric energy, it may include an assembly for transmitting a requested driving operation to the wheel driving unit 118 (e.g., an inverter-controlled motor drive assembly, etc.). When the vehicle is operated based on fossil energy, the actuating unit 116 may include a transmission and a gear module for transmitting power of an internal combustion engine.

The wheel driving unit may include a plurality of wheels, a driving force generation module for generating a driving force and applying it to the wheels or transmitting the driving force, a braking module for decelerating driving of the wheels, and a steering module for realizing transverse control of the wheels. When the vehicle 100 is driven based on electric energy, the driving force generation module may be configured as a motor assembly that generates a driving force based on power output from an electric battery. The braking module of the electric-based vehicle 100 may further have a regenerative braking function (e.g., energy recovery during deceleration or downhill driving, etc.).

The vehicle 100 may also include a memory 118 and the processor 120. The memory 118 stores an application and various data for control of the vehicle 100, and load the application or read and write the data depending on a request of the processor 120 (e.g., driving logs, configuration files, or map databases, etc.). The application may be executed by the processor 120 with built-in at least one controller that performs a specific function. In the present disclosure, the controller may also be referred to as a vehicle controller.

In the present disclosure, the memory 118 may hold an application that manages resources of the vehicle controller. The application for resource management may include software that monitors a plurality of components having dependencies in the controller and a state of a bus path used by the components, and executes, based on a specific state, reducing a throughput or a usage data amount of a specific component according to reduction information (e.g., lowering PCIe throughput or DRAM access rate under heavy load, etc.).

Dependency may mean that there is another specific bus or processing of a specific component when executing processing related to vehicle control or processing of another component that is affected by transmission of a specific bus path (e.g., when Ethernet congestion delays data access through DRAM or PCIe, etc.). Specifically, when processing/transmission in another component or another specific bus path is delayed by a delay in processing of the specific component or a delay in the specific bus path occurring, the components or the bus paths may be interdependent.

The reduction information may include, for example, data defining maximum usage of components and bus paths, reduction limits applied in reduction of designated components, and priorities of components to be reduced (e.g., maximum DRAM throughput, PCIe bandwidth limits, or priority tables for throttling, etc.). The reduction information is stored in the memory 118, and a detailed description of the reduction information is provided below.

The processor 120 may perform overall control of the vehicle 100. The processor 120 may be configured to execute applications and instructions stored in the memory 118 (e.g., perception, planning, control, or user-interface tasks, etc.).

As described above, the processor 120 may include a vehicle controller that executes applications related to the processing of various controls in the vehicle 100. The vehicle controller may be, for example, but not limited to, an Electric Control Unit (ECU), a Motor Control Unit (MCU), a Transmission Control Unit (TCU), a Battery Management System (BMS), an autonomous driving controller, an air conditioning controller, an Electric Drive Control Unit (EDCU), a vehicle communication network controller, or the like, and may be a controller of various functions (e.g., body control, infotainment, or ADAS domain controllers, etc.). The application may be at least one software program that processes the control associated with the above-described example. The vehicle controller of the illustrated type may process a number of functions associated with that controller.

Taking the ECU as an example for the vehicle controller, the vehicle controller ECU may handle powertrain control, transmission control, brake control, regenerative braking control, lighting control, door lock control, safety device control, infotainment control, suspension control, and the like (e.g., traction management, battery temperature control, or energy optimization, etc.). The powertrain may be, for example, any one of an engine, an electric battery/motor, a fuel cell/electric battery/motor.

Although vehicle controllers of various functions are illustrated in the present disclosure as being mounted on a single processor 120, the ECU, the MCU, the TCU, the BMS, the autonomous driving controller, the air conditioning controller, the EDCU, the vehicle communication network controller, and the like may be distributed and installed for each controller (e.g., zonal architecture or centralized compute configurations, etc.). Although a plurality of vehicle controllers are described in the present disclosure to be embedded in a virtual single processor 120 for convenience of description, the present disclosure may be applied substantially equally to an example in which each vehicle controller is implemented as a separate processor.

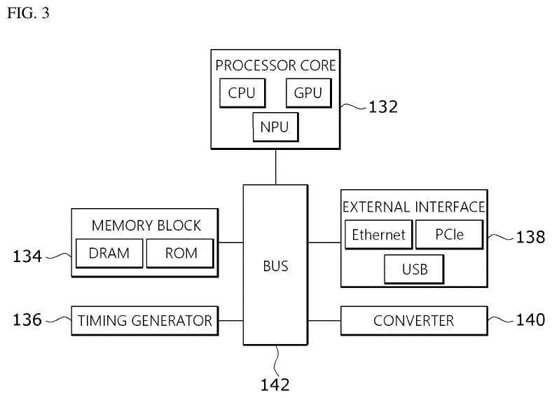

The controller of the vehicle 100 may be implemented as a system on chip (SoC), for example. The controller includes modules having various functions, and may include a processor core 132, a memory block 134, a timing generator 136, an external interface 138, and a converter 140, as illustrated in FIG. 3. FIG. 3 shows an example of modules of a controller implemented in a processor. A bus 142 may be used to exchange data between components. The above-described modules are exemplary, and the vehicle controller may further include other modules (e.g., a power management circuit, a temperature control module, or a sensor fusion unit, etc.).

For example, the processor core 132 may include a CPU, a GPU, a Neural Processing Unit (NPU), a microcontroller, and a digital signal processor as components (e.g., an AI accelerator, a vision processing circuit, or an image signal processor, etc.). The processor core 132 may be configured as a multi-core (e.g., dual-core, quad-core, or heterogeneous multi-core architecture, etc.). The memory block 134 is a storage of the controller, and may include, for example, a DRAM, a ROM, and a flash memory as components (e.g., LPDDR5, SRAM, or non-volatile MRAM, etc.). The timing generator 136 may include a timing generator phase-locked route (PPL), for example. The external interface 138 may include at least one of an Ethernet, a PCIe, and a Universal Serial Bus (USB), for example, as a component (e.g., a controller area network (CAN), a low-voltage differential signaling (LVDS) interface, or a wireless transceiver interface, etc.). The converter 140 may include an analog-to-digital converter and a digital-to-analog converter as components, for example (e.g., a successive approximation ADC, a sigma-delta ADC, or a pulse-width modulation DAC, etc.). In the present disclosure, a component to be monitored and reduced due to interdependence is a high-speed input/output device that is mainly a type of a non-processing unit, and may include components of a memory block and an external interface, for example (e.g., DRAM, PCIe controller, or Ethernet PHY, etc.). However, the present disclosure is not limited thereto, and if components of different modules have dependencies on different components, these components may also be monitored and reduced (e.g., timing circuits, voltage regulators, or sensor interfaces, etc.).

The bus 142 uses various communication manners, and communication between components may be performed. Data transmission between components may use, for example, a network-on-chip (NOC) manner (e.g., mesh topology, ring topology, or hybrid tree topology, etc.). The NOC manner may manage communication between components of the SoC network-wise. Data transmission between the components may use at least one optimal path generated based on routing of the NOC, rather than a point-to-point manner (e.g., direct bus, crossbar, or daisy-chain, etc.).

For example, the NOC method may employ the processor core 132, the memory block 134, the external interface 138, and the components of the peripheral device as nodes, and may include transmitting data packets between the nodes using at least one optimal path established by routing and a network topology (e.g., deterministic routing, adaptive routing, or congestion-aware routing, etc.). The optimal path may include an intermediate node selected between a transmitting node and a receiving node and a bus path connecting each node (e.g., a link-level router, a buffer switch, or a gateway node, etc.). Accordingly, the bus path may include a combination of transmission lines of the bus 142 generated based on routing of the NOC (e.g., high-speed serial lines, optical interconnects, or differential pairs, etc.). In addition, the router that generates the optimal path and the bus path may be, but is not limited to, the processor core 132 and may be provided as a separate module in the SoC (e.g., a dedicated NOC management controller or a traffic scheduling circuit, etc.).

In the context of the present disclosure, the processor 120 may execute a process of monitoring an amount of component data used by a plurality of components having dependencies in the controller and an amount of bus data transmitted on a bus path used by the components (e.g., memory bandwidth usage, peripheral I/O throughput, or internal cache traffic, etc.). The processor 120 may perform a process of determining whether at least one of the amount of component data and the amount of bus data is a maximum usage amount of each. In addition, the processor 120, in response to the amount of data equal to or greater than the maximum usage amount, may execute a process for reducing the amount of the component data of the reduction component determined based on the reduction information, thereby reducing resources of the component (e.g., lowering bus transfer rate, limiting DMA transaction size, or throttling peripheral update frequency, etc.).

Meanwhile, the processor 120 is illustrated to be configured as a single processing module, as in FIG. 2, for the above-described processing. In another example, the processor 120 may be configured as a plurality of processing modules, and the processing may be distributed and processed in the plurality of modules (e.g., distributed across CPU cores, GPU threads, or dedicated accelerator units, etc.).

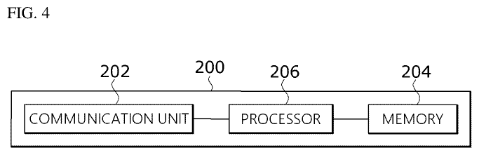

FIG. 4 shows an example of modules that constitutes a server according to the present disclosure.

The server 200 may transmit response data according to a request of the vehicle 100 to the vehicle 100, and may transmit an application built in the vehicle 100 and information for supporting vehicle driving to the vehicle 100 (e.g., map update data, software patch files, or navigation route information, etc.). The server 200 may include a communication unit 202, a memory 204, and a processor 206.

The communication unit 202 may transmit and receive data to and from an external device, support mutual communication with the vehicle 100 in the present disclosure, and exchange data with the vehicle 100 (e.g., through 5G, LTE, Wi-Fi, or satellite links, etc.).

The memory 204 may store a program for operating the server 200 and various data, and load the program or read and write the data according to a request of the processor 206. The memory 204 may hold and manage a program for processing a request of the vehicle 100, an application built in the vehicle 100, and information for driving support (e.g., traffic data, weather data, or vehicle diagnostic data, etc.).

The processor 206 may perform overall control of the server 200. The server 200 may be configured to execute programs and instructions stored in the memory 204. The processor 206 executes the programs to process and respond to a user's request transmitted from the vehicle 100 (e.g., providing infotainment content, remote vehicle control commands, or over-the-air (OTA) update responses, etc.).

The processor 206 is illustrated in the present disclosure as being configured as a single processing module. In another example, the processor 206 may be distributed to a plurality of processing modules, and the above processing may be executed by a distributed processing model (e.g., a cloud cluster, an edge server farm, or a load-balanced microservice network, etc.).

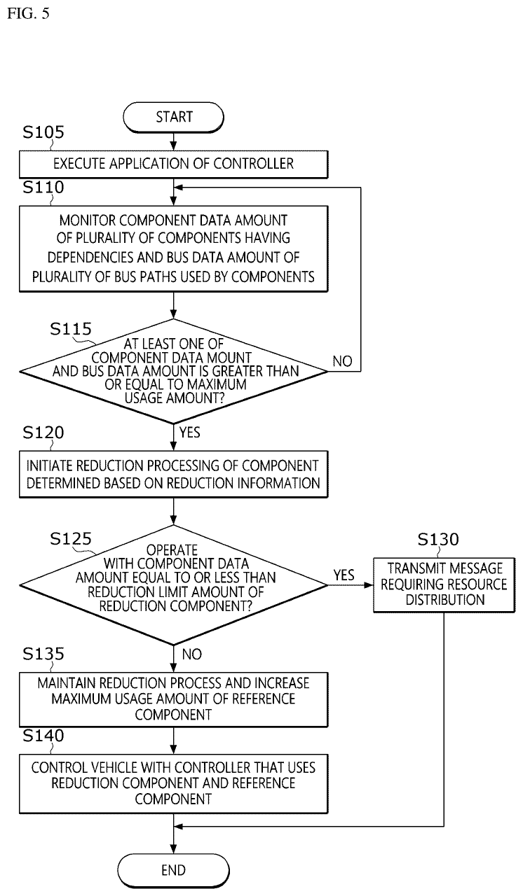

Hereinafter, a resource management method of a controller according to another implementation of the present disclosure will be described in detail with reference to FIG. 2, FIG. 3, and FIG. 5. FIG. 5 shows an example of a resource management method of a controller according to another implementation of the present disclosure. In the present disclosure, a module that executes the method is mainly a processor 120 or a processor core 132, but for convenience of description, the processor 120, the processor core 132, and the vehicle 100 may be mixed and described.

Referring to FIG. 5, the processor 120 of the vehicle 100 may load an application that performs processing of vehicle control and execute the application by using a controller (S105) (e.g., a braking control program, an adaptive cruise control routine, or a lane-keeping algorithm, etc.).

The processor 120 may monitor an amount of component data used by a plurality of components having dependencies in the controller and an amount of bus data transmitted on bus paths used by the components (S110) (e.g., data exchanged between DRAM and PCIe, between Ethernet and GPU, or among multiple cache layers, etc.).

In the present disclosure, the monitored component may include at least a component included in the memory block 134 and the external interface 138. In the present disclosure for convenience of description, the component of the memory block 134 may be illustrated by a DRAM shown in FIG. 3. The component of the external interface 138 may be illustrated by an Ethernet, a PCIe, and a universal serial bus illustrated in FIG. 3. The monitored component is not limited to the above examples, and may include other components having a dependency (e.g., a wireless communication module, a sensor interface, or a camera processing circuit, etc.). Description of the dependency will be omitted as it is described in FIG. 3. A bus path used by the components may be connected to the DRAM, the Ethernet, the PCIe, or the like, and include at least one transmission path used by these components (e.g., a shared internal data bus, a crossbar switch, or a network-on-chip (NOC) interconnect, etc.). The bus path may be generated based on a NOC architecture according to routing of the NOC.

The processor 120 may determine whether at least one of the component data amount and the bus data amount is greater than or equal to each maximum usage amount (S115).

The maximum usage amount is defined in reduction information, and the reduction information may further include reduction data (e.g., reduction priorities, limit values, or control coefficients, etc.).

Specifically, the reduction information may include a maximum usage per component and a maximum usage per bus path that have an interdependence (e.g., CPU-to-memory bandwidth limits, GPU-to-PCIe limits, or Ethernet-to-NOC limits, etc.). The maximum usage of a component is an amount of data processed in the component, and the amount of bus data may be a usage band of the bus path. The component defined in the reduction information may include a reference component for which management of resource is required and an association component that has dependency on the reference component (e.g., Ethernet as a reference and DRAM or PCIe as association circuits, etc.). The reference component may be defined as at least one component that affects causing a processing delay of the association component (e.g., a congested communication interface, a high-latency memory, or a busy interconnect path, etc.). The reference component may be a component that causes frequent delays compared to the association component, resulting in a large load. The amount of data processed by other components may be reduced by the processing delay of the reference component, so that the reference component may be a component that affects the processing rate of the other components.

The maximum usage of the component and the maximum usage of the bus path may be set based on the amount of component data and the amount of bus data used for each process executed by the controller (e.g., object recognition, path planning, or powertrain control, etc.). The vehicle controller may perform different processes for each operation scenario of the vehicle 100 (e.g., autonomous driving, remote parking, or manual driving, etc.). For example, when the vehicle controller functioning as an ECU performs an autonomous driving function, the autonomous driving function may execute detailed processing. Cognitive processing may use an NPU in addition to an CPU and an GPU, and when the cognitive processing uses the NPU, the amount of component and bus data may be increased compared to the detailed processing that does not use the NPU. The maximum usage of a component and the maximum usage of a bus path may be set based on the amount of component data and the amount of bus data of a process that does not use the NPU and a process that uses the NPU (e.g., AI-based perception vs. rule-based control logic, etc.).

The reduction data of the reduction information may be provided to reduce an amount of component data of the association component, so as to reduce a processing burden of the controller (e.g., lowering DMA frequency, limiting peripheral access rate, or compressing transmitted data, etc.). When the amount of data of the reference component is reduced, the processing delay of the association component may be weighted, so as to suppress a processing delay of the controller. Accordingly, the reduction data may be generated such that the reference component is not designated as the reduction component, and the association component is designated as the reduction component (e.g., prioritizing Ethernet operation while throttling DRAM or PCIe usage, etc.).

As an example, the reduction data of the reduction information may include a reduction limit amount for each association component and a reduction priority given for each of the plurality of association components (e.g., DRAM, PCIe, or USB, etc.). Here, a reduction limit amount and a reduction priority of the reference component may not be given (e.g., the Ethernet interface may be excluded from reduction prioritization, etc.).

The reduction limit amount may be a minimum required amount of data of the association component even if the reduction limit amount reduces the amount of data used by the reducing association component (e.g., maintaining a minimum memory bandwidth or PCIe throughput, etc.). The reduction limit amount may be set to prevent a processing delay of the reduction component to ensure a minimum processing efficiency. The reduction limit amount may be set adaptively to a change of the current processing executed in the vehicle controller (e.g., adaptive tuning based on CPU/GPU/NPU workload, operating temperature, or driving mode, etc.). As in the above example, the amount of data of a component in the NPU-based processing may require a larger amount of processing compared to the processing not using the NPU. If the processing is changed from the processing without using the NPU to the NPU-based processing, the reduction limit amount of the component related to the NPU-based processing is increased, and if the processing is changed in reverse, the reduction limit of the corresponding component may be reduced (e.g., increasing DRAM bandwidth during neural inference and reducing it during rule-based control, etc.).

The reduction priority may define an order of association components that apply reduction (e.g., first USB, then PCIe, then DRAM, etc.). The reduction component included in each ranking may be defined as a single component or a combination of a plurality of components (e.g., a DRAM-PCIe pair or a group of I/O controllers, etc.). The reducing priority may be set adaptively to a change in processing executed in the vehicle controller (e.g., adjusting priorities depending on real-time sensor fusion, image recognition, or navigation processing loads, etc.). For example, when the components are DRAM and PCIe, and the PCIe communication is a priority operation scenario, a reduction priority of PCIe may be set lower than that of USB. A reduction limit amount of PCIe may be increased based on the reduction priority and the operation scenario that are changed (e.g., prioritizing high-speed data exchange with an external sensor module, etc.). In some cases, a reduction limit amount of USB may also be reduced based on the ranking and the operation scenario (e.g., deprioritizing infotainment or peripheral charging functions during autonomous driving, etc.).

In order to adaptively change the reduction limit amount and the reduction priority, the process according to steps S110 to S135 related to monitoring whether the process is changed, the component data amount, and the bus data amount may be executed in the background during execution of the application (e.g., while the vehicle is performing perception, planning, or control tasks, etc.).

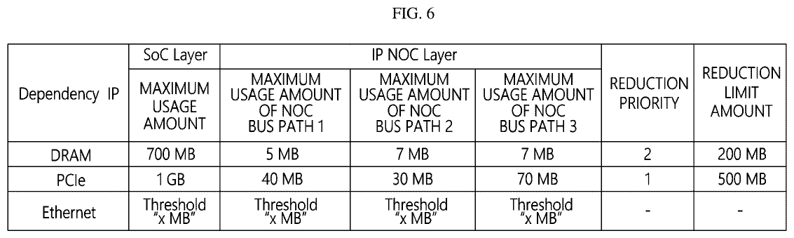

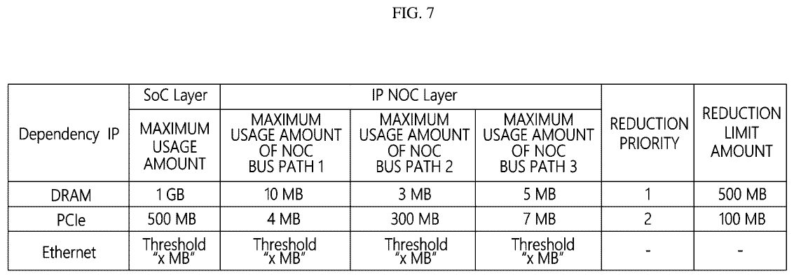

The reduction information including the maximum usage amount and the reduction data for each component and bus path may be provided in the form of a table, as illustrated in FIGS. 6 and 7. FIG. 6 shows an example of the reduction information including the maximum usage amount and the reduction data. FIG. 7 shows another example of the reduction information including the maximum usage amount and the reduction data.

In FIG. 6 and FIG. 7, dependency intellectual property (IP) corresponding to a component having dependency is exemplified by DRAM, PCIe, and Ethernet. The reference component is Ethernet that is a target of resource management, and the association component is exemplarily illustrated by DRAM and PCIe (e.g., the DRAM serving as a data buffer for PCIe transfers managed through Ethernet, etc.). The SoC layer refers to a component on the SoC, and in this example, may be the DRAM, the PCIe, or the Ethernet. The IP NOC layer refers to a bus path established by the NOC method, and in FIG. 6 and FIGS. 7A and 7B, a plurality of bus paths used by each component are exemplified (e.g., NOC Bus Path 1, NOC Bus Path 2, or cross-layer routing paths, etc.).

As exemplified in FIG. 6 and FIG. 7, the maximum usage amount of the component and the maximum usage amount in the bus path may be set differently according to the component data amount and the bus data amount used for each process of the vehicle controller. Referring to FIG. 6 as an example to describe the determination of the use of the maximum usage amount or more, the processor 120 may determine whether the component data amount of the DRAM is 700 MB or more in maximum usage amount, or whether the bus data amount of the NOC bus path 2 used by the PCIe is 30 MB or more in maximum usage amount (e.g., exceeding preconfigured performance thresholds, etc.). That is, the processor 120 may check whether one or more of the component data amount or the bus data amount is equal to or more than respective maximum usage amount (e.g., verifying per-component bandwidth usage in real time, etc.).

In addition, the reduction priority and the reduction limit amount set in FIG. 6 and FIG. 7, respectively, are illustrated as being given to the association component. The reduction priority or the reduction limit amount in FIG. 6 or FIG. 7 is not fixed, and may be set adaptively to a change in processing executed in the vehicle controller (e.g., dynamically updated as the vehicle transitions between autonomous driving modes, etc.).

In another example, the reduction data of the reduction information may be provided to fixedly designate a single or a plurality of components to be reduced, and define a reduction limit amount of the reduction component (e.g., limiting DRAM and PCIe usage under constant high-load operation, etc.). Here, the reduction component for which the reduction limit amount is defined is an association component, and the reduction limit amount may be adaptively varied according to a change in processing in the vehicle controller (e.g., increasing limits for real-time perception and reducing for background logging, etc.). As in one example, the reduction limit amount in another example may not be given to the reference component (e.g., keeping Ethernet or another communication interface unrestricted, etc.).

Referring back to FIG. 5, if both the component data amount and the bus data amount are less than respective maximum usage amount, the processor 120 may proceed to step S110 and perform monitoring (e.g., continuously measuring component load and bus traffic levels, etc.).

The processor 120 may initiate reduction processing of reducing the component data amount of the reduction component determined based on the reduction information, based on at least one of the component data amount and the bus data amount being greater than or equal to each maximum usage amount (S120) (e.g., throttling bus bandwidth, reallocating memory access priority, or limiting peripheral update frequency, etc.).

Exemplifying the reduction processing according to reduction information of FIG. 6, the processor 120 may adopt an association component corresponding to a reduction component, based on the processing rate of the controller, the processing delay, the bus data amount of the bus path, and the processing status of the processor core 132 (e.g., CPU utilization, cache hit rate, or NPU workload, etc.). For example, if the processing burden of the controller is excessive to the extent that the processing rate, processing delay, bus data amount, or the like does not reach the respective reference value, the reduction component may be selected as only the PCIe, according to the reduction priority illustrated in FIG. 6 (e.g., limiting PCIe transfer rate while maintaining DRAM and Ethernet at nominal operation, etc.). On the other hand, if the processing burden of the controller is excess to the extent that at least one of the processing rate, process delay, and bus data amount reaches the respective reference value, the reduction components may be selected as the PCIe and the DRAM (e.g., throttling both PCIe and DRAM access frequencies to rebalance bus bandwidth, etc.), according to the reduction priority illustrated in the FIG. 6.

As another example, when the reduction information provides a component that is fixedly designated as a reduction component without reduction priority, the processor 120 may initiate reduction processing for the component designated as the reduction component (e.g., a predefined low-priority I/O interface such as USB or Wi-Fi, etc.).

Referring to FIG. 5, the processor 120 may determine whether the reduction component is operated with the component data amount equal to or less than the reduction limit amount by the reduction process (S125) (e.g., verifying whether the PCIe data rate remains below the 500 MB threshold, etc.).

Taking the operation of the reduction component according to the reduction limit of FIG. 6 as an example, the processor 120 may detect whether the PCIe designated as the reduction components operates while using a component data amount less than or equal to the reduction limit 500 MB (e.g., measuring effective throughput via internal performance counters, etc.).

In response to the reduction component being operated with the component data amount less than or equal to the reduction limit amount, the processor 120 may generate a message requesting resource distribution of the component and transmit, via the display 108 or the like, the message to notify a user (S130) (e.g., displaying a system load warning, resource reallocation prompt, or optimization status message, etc.).

The user may request, according to the message, an instruction related to the resource distribution to the processor 120 (e.g., selecting “performance mode,” “balanced mode,” or “power-saving mode,” etc.). In another example, the processor 120 may reconfigure, based on the request of the generated message, the resource distribution related to the reduction process (e.g., redistributing memory bandwidth, modifying DMA scheduling, or adjusting task priority among processor cores, etc.).

The processor 120 may maintain the reduction that reduces the component data amount of the reduction component and increase the maximum usage amount of the reference component in response to the reduction component operating in excess of the reduction limit amount (S135) (e.g., freeing bus resources for Ethernet when PCIe load drops below threshold, etc.).

According to the example of FIG. 6, the processor 120 may control the operation of the PCIe while reducing the component data amount of the PCIes to the reduction limit amount, based on the PCIe designated as the reduction component operating in excess of the reduction limit amount of 500 MB (e.g., automatically throttling transaction size or packet frequency, etc.). Accordingly, the processing of the components and the transmission burden of the bus path may be reduced (e.g., lowering congestion across shared NOC paths, etc.).

In addition, a maximum usage amount of a reference component, for example, the Ethernet exemplified in FIG. 6, is increased, so that the Ethernet may be allocated with a free resource (e.g., allocating additional channel bandwidth or DMA buffers, etc.). Therefore, a processing burden of the Ethernet, that is, the reference component, may be alleviated (e.g., improving network response time or reducing packet latency, etc.).

The processor 120 may control the vehicle with processing related to the application by executing the application using the controller that uses the reduction component, the association component, and the reference component (S140) (e.g., performing autonomous driving control, powertrain management, or sensor data fusion with balanced controller resource usage, etc.).

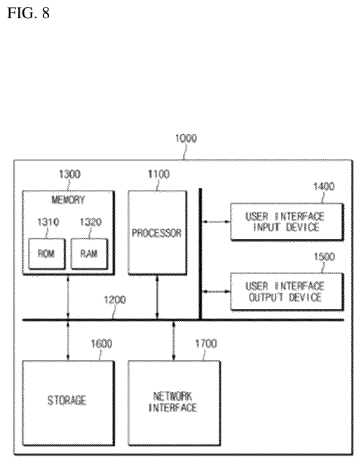

FIG. 8 shows an example computing system (e.g., a computing device of a vehicle or any other apparatus). One or more controllers, processors, etc. described herein, such as one or more components of the vehicle 100, or any other components and devices disclosed herein, may be implemented by or in the computing system as shown in FIG. 8.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with examples disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to implementation of the present disclosure, there is provided A method for controlling resource of a controller, comprising: monitoring a component data amount used by a plurality of components having dependencies in a controller and a bus data amount transmitted on bus paths used by the components; determining whether one or more of the component data amount or the bus data amount is greater than or equal to respective maximum usage amount; and reducing a resource of the component to reduce a component data amount of a reduction component determined based on reduction information, in response to the data amount being greater than or equal to the maximum usage amount.

According to the example of the present disclosure in the method, the bus path may comprise a plurality of bus paths generated based on routing of a Network on Chip (NOC).

According to the example of the present disclosure in the method, the plurality of components may comprise a reference component for which management of resource is required and an association component that depends on the reference component, and the bus path comprises a bus path that depends on the reference component and is used by the component.

According to the example of the present disclosure in the method, the maximum usage amount of the component and the maximum usage amount in the bus path may be set based on the component data amount and the bus data amount used for each process executed in the controller.

According to the example of the present disclosure in the method, the plurality of components may comprise a reference component for which management of resource is required and an association component that depends on the reference component, and the reduction information may be provided to reduce the component data amount of the association component.

According to the example of the present disclosure in the method, the reduction information may comprise a reduction limit amount of the component. Also, the reducing the resource of the component may comprise determining, by reduction of the resource of the component, whether the reduction component is operated with a component data amount less than or equal to the reduction limit amount; and maintaining a reduction that reduces a component data amount of the reduction component in response to the reduction component operating in excess of the reduction limit amount.

According to the example of the present disclosure in the method, the reduction limit amount may be set adaptively to a change in processing executed in the controller.

According to the example of the present disclosure in the method, the method may further comprise transmitting a message requesting resource distribution of the component, in response to the reduction component being operated with a component data amount less than or equal to the reduction limit amount.

According to the example of the present disclosure in the method, the reduction information may comprise a reduction priority assigned to each of the plurality of components. Also, the reducing the resource of the component may comprise reducing a data amount of the reduction component determined based on the reduction priority.

According to the example of the present disclosure in the method, the reduction priority may be adaptively set based on a change in processing executed in the controller.

According to another implementation of the present disclosure, there is provided A vehicle for managing resource of a controller, the vehicle comprising: a memory storing at least one instruction; and at least one processor executing the at least one instruction stored in the memory and including a controller that performs processing related to control of the vehicle. The at least one processor is configured to: monitor a component data amount used by a plurality of components having dependencies in a controller and a bus data amount transmitted on bus paths used by the components; determine whether one or more of the component data amount or the bus data amount is greater than or equal to respective maximum usage amount; and reduce a component data amount of a reduction component determined based on reduction information, in response to the data amount being greater than or equal to the maximum usage amount, to reduce a resource of the component.

According to the present disclosure, it is possible to provide a method and vehicle for managing resource of a controller that stably distribute resources of the controller during high-speed communication. The effects that may be obtained in the present disclosure are not limited to the above-mentioned effects, and other effects that are not mentioned will be clearly understood by those skilled in the art to which the present disclosure belongs from the description below.

While the exemplary methods of the present disclosure are described above and represented as a series of operations for clarity of description, it is not intended to limit the order in which the steps are performed, and the steps may be performed simultaneously or in different order as necessary. In order to implement the method according to the present disclosure, the described steps may further include other steps, may omit some of the steps, or may include other additional steps as appropriate.

The various implementations of the present disclosure are not a list of all possible combinations and are intended to describe representative examples of the present disclosure, and the matters described in the various implementations may be applied independently or in any combination of two or more.

In addition, various implementations of the present disclosure may be implemented in hardware, firmware, software, or a combination thereof. In the case of implementing the present disclosure by hardware, the present disclosure can be implemented using application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various implementations to be executed on an apparatus or a computer, and a non-transitory computer-readable medium having such software or commands stored thereon and executable on the apparatus or the computer.

What is claimed is:

1. A method performed by a vehicle, the method comprising:
monitoring an amount of data used by a plurality of circuits having dependencies in a processor of the vehicle and an amount of bus data transmitted on bus paths used by the plurality of circuits;
determining whether at least one of the amount of data or the amount of bus data is greater than or equal to a respective threshold usage amount;
determining, based on reduction information of the vehicle and a determination that at least one of the amount of data or the amount of bus data is greater than or equal to the respective threshold usage amount, a reduction target circuit among the plurality of circuits;
outputting a signal instructing to reduce an amount of data used by the reduction target circuit; and
controlling, based on the signal, operations of the vehicle.

2. The method of claim 1, wherein the bus paths comprise a plurality of bus paths generated based on routing of a Network on Chip (NOC).

3. The method of claim 1, wherein the plurality of circuits comprise a reference circuit for which management of resource is required and an association circuit that depends on the reference circuit, and wherein the bus paths comprise a bus path that depends on the reference circuit and is used by the association circuit.

4. The method of claim 3, wherein the threshold usage amount for the amount of data and the threshold usage amount for the amount of bus data are set respectively for the association circuit and the reference circuit.

5. The method of claim 1, wherein the plurality of circuits comprise a reference circuit for which management of resource is required and an association circuit that depends on the reference circuit, wherein the reduction information is configured to reduce the amount of data, and wherein the amount of data is used by the association circuit.

6. A vehicle comprising:
a plurality of circuits configured to control operations of the vehicle;
a plurality of bus paths configured to exchange data between the plurality of circuits;
a memory configured to store at least one reduction parameter associated with the vehicle, wherein the at least one reduction parameter comprises at least one reduction limit amount and at least one reduction priority for at least one of the plurality of circuits; and
a processor circuit configured to:
determine an amount of data used by the plurality of circuits and an amount of bus data transmitted on the plurality of bus paths,
determine whether at least one of the amount of data or the amount of the bus data exceeds a respective threshold usage amount, and
based on the respective threshold usage amount being exceeded and the at least one reduction parameter, select the at least one of the plurality of circuits as a reduction target, and
based on the at least one reduction limit amount and the at least one reduction priority, output a signal indicating to adjust a data usage of the reduction target, and
control, via the plurality of circuits and based on the signal, operations of the vehicle.

7. The vehicle of claim 6, wherein the processor circuit is configured to:
classify the plurality of circuits into high-priority circuits and low-priority circuits based on the at least one reduction parameter,
based on the respective threshold usage amount being exceeded, use the at least one reduction parameter to select at least one of the low-priority circuits as the reduction target and reduce the data usage of the reduction target.

8. The vehicle of claim 6, wherein the processor circuit is configured to adjust the at least one reduction limit amount based on a change in processing executed in the plurality of circuits, wherein the adjustment of the at least one reduction limit amount comprises:
increasing the at least one reduction limit amount for processing using a neural processing unit, and
decreasing the at least one reduction limit amount for processing not using the neural processing unit.

9. The vehicle of claim 6, wherein the processor circuit is configured to set a reduction priority of each of the plurality of circuits based on an operation of the vehicle, by:
assigning a lower reduction priority to circuits that perform a priority function in the operation, and
assigning a higher reduction priority to circuits that perform a non-priority function in the operation.

10. The vehicle of claim 6, wherein the processor circuit is configured to output, via a user interface of the vehicle, a message requesting resource distribution, based on the data usage of the reduction target having been reduced to at or below the at least one reduction limit amount, and wherein the at least one reduction limit amount corresponds to a minimum amount of data that must be allowed for the reduction target to use.

11. A vehicle comprising:
a processor; and
a memory storing at least one instruction that, when executed by the processor, is configured to cause the vehicle to:
monitor an amount of data used by a plurality of circuits having dependencies in control circuitry and an amount of bus data transmitted on bus paths used by the plurality of circuits,
determine whether at least one of the amount of data or the amount of bus data is greater than or equal to a respective threshold usage amount,
determine, based on reduction information of the vehicle and a determination that at least one of the amount of data or the amount of bus data is greater than or equal to the respective threshold usage amount, a reduction target circuit among the plurality of circuits,
output a signal indicating to reduce an amount of data used by the reduction target circuit, and
control, based on the signal, operations of the vehicle.

12. The vehicle of claim 11, wherein the bus paths comprise a plurality of bus paths generated based on routing of a Network on Chip (NOC).

13. The vehicle of claim 11, wherein the plurality of circuits comprise a reference circuit for which management of resource is required and an association circuit that depends on the reference circuit, and wherein the bus paths comprise a bus path that depends on the reference circuit and is used by the association circuit.

14. The vehicle of claim 13, wherein the threshold usage amount for the amount of data and the threshold usage amount for the amount of bus data are set respectively for the association circuit and the reference circuit.

15. The vehicle of claim 11, wherein the plurality of circuits comprise a reference circuit for which management of resource is required and an association circuit that depends on the reference circuit, wherein the reduction information is configured to reduce the amount of data, and wherein the amount of data is used by the association circuit.

16. The vehicle of claim 15, wherein the reduction information comprises a reduction limit amount, wherein the reduction limit amount corresponds to a minimum amount of data that must be allowed for the association circuit to use, and wherein the at least one instruction, when executed by the processor, is configured to cause the vehicle to:
determine whether the association circuit is using an amount of data less than or equal to the reduction limit amount; and
reduce the amount of data used by the association circuit based on a determination that the amount of data exceeds the reduction limit amount.

17. The vehicle of claim 16, wherein the reduction limit amount is adjusted based on a change in processing executed in the plurality of circuits.

18. The vehicle of claim 16, wherein the at least one instruction, when executed by the processor, is configured to cause the vehicle to transmit a message requesting resource distribution of the reference circuit, based on the reduction target circuit being operated with an amount of data less than or equal to the reduction limit amount.

19. The vehicle of claim 11, wherein the reduction information comprises a reduction priority assigned to each of the plurality of circuits, and wherein the at least one instruction, when executed by the processor, is configured to cause the vehicle to reduce an amount of data of the reduction target circuit, wherein the reduction target circuit is selected based on a corresponding reduction priority.

20. The vehicle of claim 19, wherein the at least one instruction, when executed by the processor, is configured to cause the vehicle to adjust the reduction priority based on a change in processing executed in the plurality of circuits.
